(19) United States
(12) Patent Application Publication
(10) Pub. No.: US 2008/0191563 A1
(43) Pub. Date: Aug. 14, 2008

(54) Portable Power Tool With An Electric Motor and an Electronic Control and Communication Module

(75) Inventor: Nils Thomas Meldert, Amal (SE)

Correspondence Address: FRISHAUF, HOLTZ, GOODMAN & CHICK, PC, 220 Fifth Avenue, 16TH Floor, NEW YORK, NY, 10001-7708, US

(73) Assignee: Atlas Copco Tools AB, Nacka (SE)

(21) Appl. No.: 11/914,904

(22) PCT Filed: May 19, 2006
(86) PCT No.: PCT/SE2006/000579

§ 371 Date: Mar. 13, 2008

(30) Foreign Application Priority Data
May 20, 2005 (SE) 0501132-5

(51) Int. Cl. H02K 5/22; H02K 7/14

(52) U.S. Cl. 310/50; 310/71; 310/43

(57) ABSTRACT

An electric power tool has a motor with a stator and a rotor, an electronic module for operation control and signal and power communication, and a connector for a cable plug connecting the tool to a stationary remote control unit. The electric power tool includes an electric interface between the motor stator and the electronic module including a number of contact elements rigidly attached to the electronic module and a number of matching contact elements rigidly supported on the motor stator to enable quick plug-in between the stator and the electronic module.

The invention relates to a portable power tool of the type including a housing, an electric motor with a rotor, a stator and stator windings, an electronic module for operation control and signal and power communication, and a cable connection means for connecting the tool to a control unit, wherein the stator windings are connected to the cable connection means via the electronic module.

A problem concerned with present power tools of the above type is that they involve a rather tricky and time consuming assembly procedure due to wiring routing and connections, which cause unnecessarily time consuming and costly assembly and service operations.

It is the main object of the invention to create a power tool by which the above problem is avoided. This is accomplished by providing an improved electric interface between the stator windings and the electronic module, and also by improving the cable connection means.

Further objects and advantages of the invention will appear from the following specification and claims.

A preferred embodiment of the invention will below be described in detail with reference to the accompanying drawings. In the drawings:

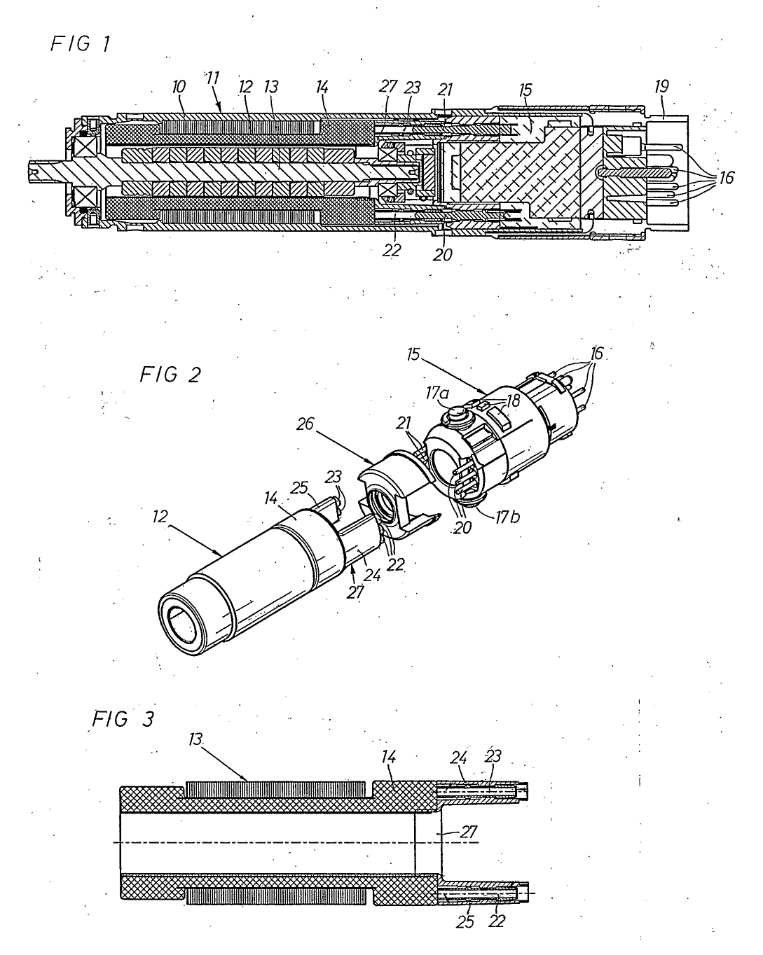

FIG. 1 shows a longitudinal section through a power tool according to the invention.

FIG. 2 shows an exploded perspective view of the motor stator, the rear rotor bearing cage, and the electronic module.

FIG. 3 shows a longitudinal section through the motor stator.

The power tool shown in the drawing figures is an electric power wrench spindle unit comprising a housing 10, a permanent magnet motor 11 with a stator 12, and a rotor 13. The stator 12 comprises windings 14 for generating a driving torque on the rotor 11, and a non-illustrated heat sensor for delivering electric signals in response to the actual motor temperature.

In the housing 10 there is also supported an electronic module 15 for tool operation control and signal and power communication and containing a plurality of electronic components as well as signal emitting means (not described in further detail). The electronic module 15 is encapsulated in a plastic moulding, illustrated in FIG. 1 by a dash-line hatching, to provide a safe protection against external disturbances like moisture. Further, the electronic module 15 is provided at its rear end with contact means in the form of contact pins 16 for interconnection with matching contact sockets on a connector plug of a non-illustrated cable connecting the tool to a remote stationary control unit. A threaded socket 19 on the housing 10 is arranged to be engaged by a nut on the connector plug. The electronic module 15 also comprises operation control buttons 17 a,b and signal lights 18.

At its forward end the electronic module 15 is provided with rigid contact pins 20 a-c and 21 a,b forming an electric interface with matching contact sockets 22 a-c and 23 a,b on the stator 12 communicating with the stator windings 14, including the heat sensor. As best seen in FIGS. 2 and 3, the contact sockets 22 a-c and 23 a,b are supported on a stator end piece 27 having two rear extensions 24, 25, such that the contact sockets 22 a-c and 23 a,b reach axially beyond a bearing support 26 mounted at the rear end of the stator 12.

By forming the electronic module 15 with rigidly mounted contact elements, as the contact pins 16 in the described example, for co-operation with matching contact elements 22, 23 on the stator 12 the electronic module 15 has been given the form of a quick plug-in unit which is advantageous as it contributes to considerably reduce the time and cost at the assembly of the power tool. Also by encapsulating the entire electronic module 15 in a plastic moulding the electronic module 15 gets a more rugged design and is easier to handle without exposing the sensitive electronic components, circuit boards, wiring etc. to damage risks during tool assembly.

1. A portable power tool, comprising:
a housing,
an electric motor with a rotor,
a stator, and stator windings,
a cable connection means for connecting the power tool to a stationary control unit via a cable, and
an electronic module for operation control and signal communication arranged between the stator and the cable connection means and having electronic components for treating electric signals and emitting signals,
wherein an electric interface is provided between one end of the electronic module and the stator and comprises a number of male contact elements and a corresponding number of matching female contact elements rigidly mounted on the stator and the electronic module for enabling quick plug-in, and
wherein the cable connection means comprises a number of contact elements rigidly mounted at an opposite end of the electronic module for cooperation with matching contact elements on a connectable cable plug.

2. The power tool according to claim 1, wherein said contact elements on the stator are carried on an end piece rigidly secured to the stator.

3. The power tool according to claim 1, wherein said end piece comprises at least one axially directed extension reaching axially past a rear rotor bearing support.

4. The power tool according to claim 1, wherein the electronic module is encapsulated by a plastic moulding leaving the contact elements for the stator connection and the contact elements for the cable connection uncovered.

5. The power tool according to claim 2, wherein said end piece comprises at least one axially directed extension reaching axially past a rear rotor bearing support.

6. The power tool according to claim 2, wherein the electronic module is encapsulated by a plastic moulding leaving the contact elements for the stator connection and the contact elements for the cable connection uncovered.

7. The power tool according to claim 3, wherein the electronic module is encapsulated by a plastic moulding leaving the contact elements for the stator connection and the contact elements for the cable connection uncovered.
